(19) United States
(12) Patent Application Publication
(10) Pub. No.: US 2006/0262252 A1
(43) Pub. Date: Nov. 23, 2006

(54) LIQUID CRYSTAL DISPLAY DEVICE AND METHOD OF MANUFACTURE THEREOF

(75) Inventors: Koji Yonemura, Tokyo (JP); Yasuhiro Morii, Tokyo (JP)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(73) Assignee: MITSUBISHI DENKI KABUSHIKI KAISHA, Chiyoda-ku (JP)

(21) Appl. No.: 11/379,146

(22) Filed: Apr. 18, 2006

(30) Foreign Application Priority Data
May 19, 2005 (JP) 2005-146473

(51) Int. Cl. G02F 1/1333

(52) U.S. Cl. 349/110

(57) ABSTRACT

A liquid crystal display device includes a TFT substrate having a plurality of pixel electrodes formed thereon, a color filter substrate having a metal light-shielding film formed thereon, a liquid crystal held between the TFT substrate and the color filter substrate, and a large number of spacers disposed in a gap between the TFT substrate and the color filter substrate, in which a voltage is applied between the pixel electrodes to generate an electric field substantially parallel to the TFT substrate surface, causing the liquid crystal to respond in an in-plane direction based on the electric field. The liquid crystal display device further includes a convex portion by increasing the thickness over at least part of the metal light-shielding film by using a photoresist used in patterning the metal light-shielding film, and the dimension of the gap between the TFT substrate and the color filter substrate is defined by the spacers interposed between the convex portion and the TFT substrate among the large number of spacers.

### BACKGROUND OF THE INVENTION

1. Field of the Invention

This invention relates to liquid crystal display devices and methods of manufacture thereof, and especially to liquid crystal display devices in which a liquid crystal responds in a in-plane direction and methods of manufacture thereof.

2. Description of the Background Art

A liquid crystal display device is thin, lightweight and consumes very little electricity, and has thus been widely used as a display element. An active-driven TN-type liquid crystal display device using a TFT (thin film transistor) and the like in particular has been widely used as a display element for a personal computer and the like. Yet the TN-type liquid crystal display device typically has a narrow angle of visibility, presenting such problems as a reduction in contrast and a tone reversal when viewed from off-center. Therefore, an in-plane switching-type liquid crystal display device has been proposed in which a voltage is applied between comblike electrodes formed on the same substrate, causing a liquid crystal to respond in a direction parallel to the substrate. The operating principles of the in-plane switching-type liquid crystal display device are discussed in Japanese Patent Application Laid-Open No. 2000-275641.

When physical vibrations or loads are given to a panel in the in-plane switching-type liquid crystal display device, however, an external force is applied to spacers that define a panel gap, sometimes causing the spacers to move. In such a case, the orientation of the liquid crystals around the spacers uniaxially falls into disorder, and incident light becomes elliptically polarized light due to the occurrence of double refraction, allowing itself to pass through a polarizing plate provided in an exit direction. This is observed as leakage of light in a black (dark) state.

The liquid crystals with poor fluidity around the spacers cannot go back afterward to an orientation direction controlled by an orientation film, continuing to be observed as the light leakage. The light leakage is observed noticeably during black display in particular, presenting such problem as a reduction in contrast ratio (luminance (transmittance) in a white (bright) state/luminance (transmittance) in a black (dark) state) which is one of the display characteristics of a liquid crystal display element. Further, a panel in which the light leakage has occurred gives the impression of having a rough display surface by visual inspection.

Therefore, in Japanese Patent Application Laid-Open Nos. 2000-275641 and 11-142863 (1999), a gap between substrates (hereafter also called a cell gap) in a display area portion is set greater than a spacer diameter, and the cell gap in a light-shielding film portion is set to substantially the same as or a little smaller than the spacer diameter. This makes spacers interposed in the light-shielding film portion define the gap between the substrates, while allowing the other spacers to move freely in a panel. Accordingly, the liquid crystals around the spacers can immediately go back to where they were upon the occurrence of uniaxial orientation disorder, preventing the light leakage.

Yet in Japanese Patent Application Laid-Open No. 2000-275641, a convex pattern is provided on the light-shielding film or on line to define the cell gap by spacers on the convex portion. Thus, new materials and new steps for forming the convex portion are required, resulting in an increase in cost.

And in Japanese Patent Application Laid-Open No. 11-142863, it is required that the light-shielding film be formed in a certain degree of thickness in order for the cell gap in the pixel portion to be greater than the spacer diameter. The thickness of the light-shielding film can be easily increased when made of organic resin. However, it is practically difficult to increase the thickness of the light-shielding film made of metals such as Cr or Ni because tact time for film-forming and etching increases, resulting in an increase in manufacturing cost, and because a substrate gets warped due to a difference in thermal expansion coefficient between the substrate and the metal light-shielding film.

### SUMMARY OF THE INVENTION

An object of this invention is to provide a liquid crystal display device capable of preventing light leakage around spacers and attaining a predetermined contrast with no increase in manufacturing cost, and a method of manufacture thereof.

In an aspect of the invention, a liquid crystal display device includes: a first substrate having a plurality of pixel electrodes formed thereon; a second substrate facing the first substrate and having a metal light-shielding film formed thereon; a liquid crystal held between the first substrate and the second substrate; and a large number of spacers disposed in a gap between the first substrate and the second substrate, in which a voltage is applied between the pixel electrodes to generate an electric field substantially parallel to a surface of the first substrate, causing the liquid crystal to respond in an in-plane direction of the surface of the first substrate based on the electric field. The liquid crystal display device further includes a convex portion by increasing the thickness over at least part of the metal light-shielding film by using a photoresist. A dimension of the gap between the first substrate and the second substrate is defined by the spacers interposed between the convex portion and the first substrate among the large number of spacers.

The liquid crystal display device further includes the convex portion by increasing the thickness over at least part of the metal light-shielding film by using the photoresist used in patterning the metal light-shielding film, and a dimension of the gap between the first substrate and the second substrate is defined by the spacers interposed between the convex portion and the first substrate among the large number of spacers. Accordingly, light leakage is prevented and a predetermined contrast is attained without having to add new materials or steps for forming the convex portion, resulting in no increase in manufacturing cost.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a cross-sectional view illustrating a liquid crystal display device according to a first preferred embodiment of this invention;

FIGS. 2A to 2D illustrate a method of manufacturing a color filter substrate according to the first preferred embodiment;

FIGS. 3A illustrates the shape of a color material layer according to a second preferred embodiment of this invention;

FIG. 3B is a plan view illustrating a color filter substrate according to the second preferred embodiment;

FIGS. 4A illustrates the shape of a color material layer according to the second preferred embodiment;

FIG. 4B is a plan view illustrating a color filter substrate according to the second preferred embodiment; and

FIG. 5 illustrates the relationship between the number of spacers on a convex portion and the level of light leakage around spacers in a liquid crystal display device according to a third preferred embodiment of this invention.

### DESCRIPTION OF THE PREFERRED EMBODIMENTS

### First Preferred Embodiment

FIG. 1 is a cross-sectional view illustrating a liquid crystal display device according to a first preferred embodiment of this invention. In this liquid crystal display device, a color filter substrate 1 and a TFT substrate 2 are disposed facing each other while maintaining a fixed cell gap therebetween. The cell gap between the color filter substrate 1 and the TFT substrate 2 is defined by spacers. In this liquid crystal display device, however, only spacers 3 positioned below a metal light-shielding film 5 define the cell gap, as can be seen from FIG. 1. Spacers 4 positioned other than below the metal light-shielding film 5 come in contact with the TFT substrate 2 side, but do not with the color filter substrate 1 side, not defining the cell gap.

A positive photoresist 6 having been used in patterning the metal light-shielding film 5 is laminated on the metal light-shielding film 5 without peeling off. Thus, upon lamination of a color material layer 7 and an overcoat layer 8 on the color filter substrate 1, only portions of the metal light-shielding film 5 become thicker than other portions to have convex portions. With only the portions of the metal light-shielding film 5 being thicker by the positive photoresist 6 to have convex portions, only the spacers 3 interposed between the convex portions and the TFT substrate 2 can define the cell gap. Although not shown, the color material layer 7 includes colors of red (R), green (G) and blue (B), and is colored on a pixel-by-pixel basis. A combination of the metal light-shielding film 5 area and a pixel area (where only the color material layer 7 is formed) is called a display area. The overcoat layer 8 is typically made of acrylic or epoxy resin, and is about 1.0 μm in thickness.

Provided on the TFT substrate 2 are scanning lines 9 and signal lines 10. The scanning lines 9 and the signal lines 10 are connected to TFTs which are not shown, and control those TFTs to apply a signal voltage to pixel electrodes which are not shown. The TFT and pixel electrode are provided on a pixel-by-pixel basis, and control a liquid crystal (not shown) held between the color filter substrate 1 and the TFT substrate 2 in each pixel. The liquid crystal display device according to the first preferred embodiment is an in-plane switching-type liquid crystal display device.

As explained in the background art section, in the in-plane switching-type liquid crystal display device, a voltage is applied to comblike pixel electrodes formed on the same substrate to generate an electric field in a direction parallel to a substrate, thereby causing a liquid crystal to respond in an in-plane direction. Thus, opposing electrodes that are typical in a TN-type liquid crystal display device are not provided on the color filter substrate 1 side.

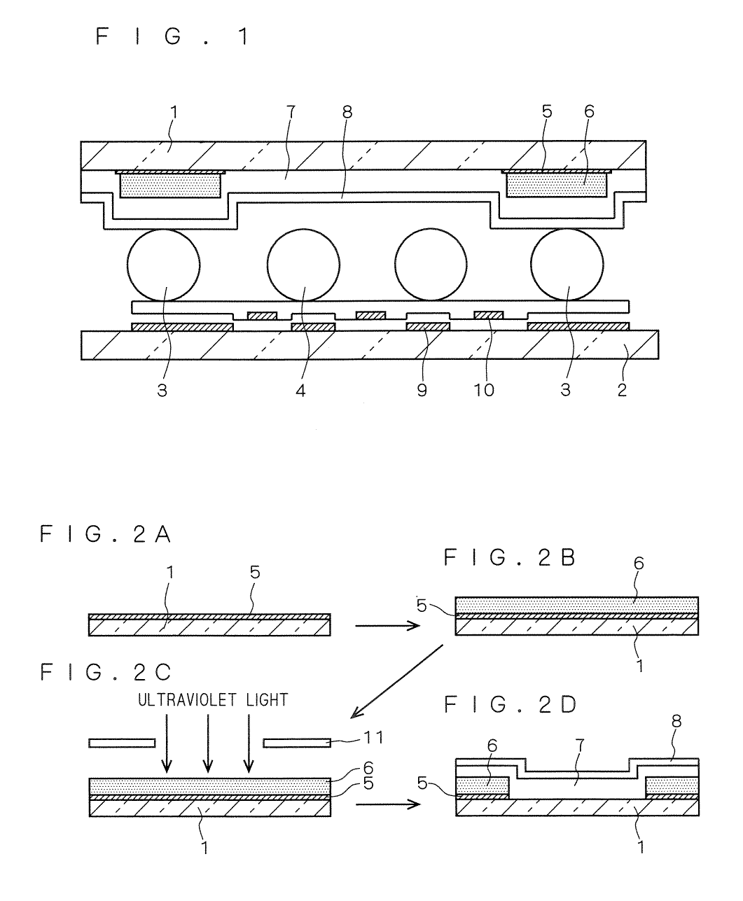

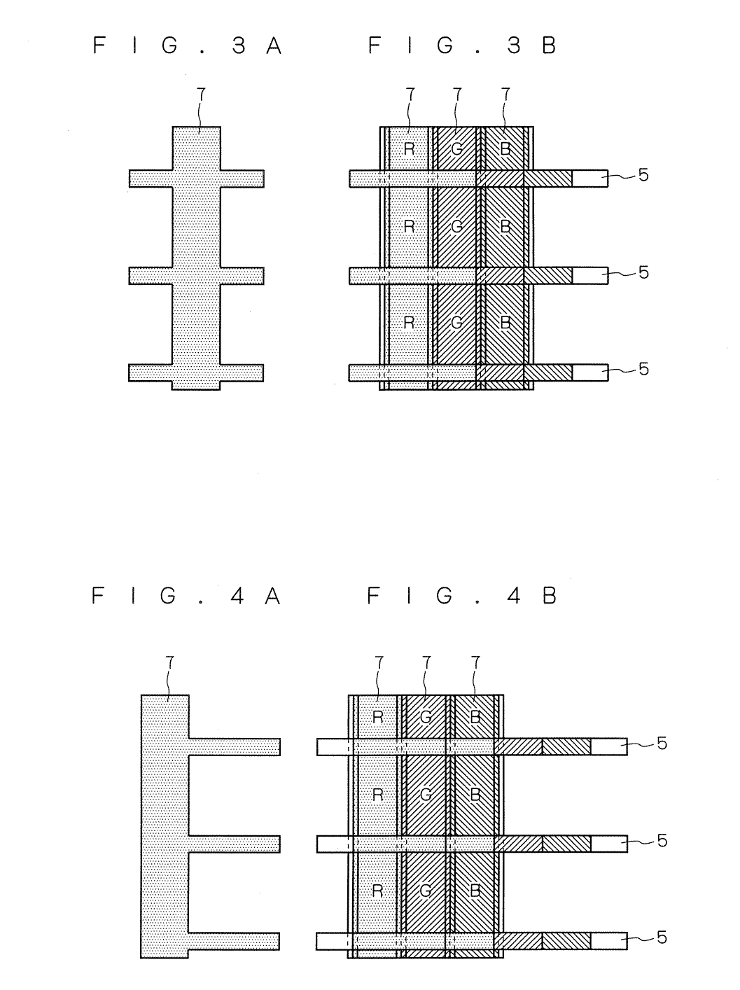

Next, a manufacturing method of forming the metal light-shielding film 5 and the like on the color filter substrate 1 according to the first preferred embodiment will be described. First, as shown in FIG. 2A, the metal light-shielding film 5 made of Cr, Ni or the like is formed on the whole surface of the color filter substrate 1 by spattering and the like. Then, as shown in FIG. 2B, the positive photoresist 6 is applied over the whole surface of the metal light-shielding film 5. The positive photoresist 6 having a predetermined thickness needs to be applied over the whole surface because the positive photoresist 6 left on the metal light-shielding film 5 defines the height of the convex portions.

Then, as shown in FIG. 2C, exposure to ultraviolet light and etching take place using a photomask 11, to pattern the metal light-shielding film 5. Namely, the metal light-shielding film 5 is patterned into a predetermined pattern using a photolithography process in FIG. 2C. In this process, the exposure takes place by covering the portions to be left of the metal light-shielding film 5 with the photomask 11 due to the use of the positive photoresist 6. In short, only the portion for forming pixels of the positive photoresist 6 is exposed to ultraviolet light as shown in FIG. 2C. Although not shown, the exposed positive photoresist 6 is then etched, thus forming the metal light-shielding film 5 having the predetermined pattern.

After forming the metal light-shielding film 5 having the predetermined pattern, the positive photoresist 6 that is left is not peeled off, but the color material layer 7 and the overcoat layer 8 are formed thereon (FIG. 2D). As such, the thickness over the metal light-shielding film 5 is increased to form the convex portions by leaving the positive photoresist 6 in the first preferred embodiment. The convex portions may be formed on the whole of, or alternatively a part of, the metal light-shielding film 5.

As described above, the liquid crystal display device according to the first preferred embodiment further includes the convex portions by increasing the thickness over at least part of the metal light-shielding film 5 by using the positive photoresist 6 used in patterning the metal light-shielding film 5, and the gap (cell gap) between the color filter substrate 1 and the TFT substrate 2 is defined by the spacers 3 interposed between the convex portions and the TFT substrate 2. Accordingly, the convex portions can be formed with the metal light-shielding film 5 whose thickness is difficult to increase without having to add new materials or steps for forming the convex portions, resulting in no increase in manufacturing cost. In addition, since the spacers 4 on pixels come in contact only with the color filter substrate 1 or the TFT substrate 2 in the first preferred embodiment, the liquid crystals around the spacers become more fluid and immediately go back to where they were upon the occurrence of orientation disorder such as vibrations, preventing light leakage and attaining a predetermined contrast.

Further, the method of manufacturing the liquid crystal display device according to the first preferred embodiment includes the steps of: forming the metal light-shielding film 5 made of a predetermined material (such as Cr or Ni) on the color filter substrate 1; forming the positive photoresist 6 on the metal light-shielding film 5; patterning the metal light-shielding film 5 by exposing the positive photoresist 6 with the predetermined photomask 11 and etching the positive photoresist 6 thereafter; and laminating the color material layer 7, the overcoat layer 8 and the like without peeling off the positive photoresist 6 on the metal light-shielding film 5. Accordingly, there is no need to add new materials or steps for forming the convex portions, resulting in no increase in manufacturing cost.

### Second Preferred Embodiment

In the first preferred embodiment, the convex portions were formed by using the positive photoresist 6. In a liquid crystal display device according to a second preferred embodiment of this invention, the color material layers 7 of at least two colors are laminated to form the convex portions.

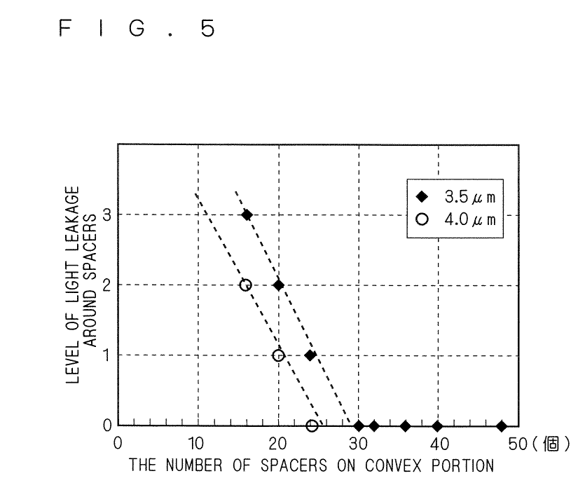

The liquid crystal display device provides color display by coloring the color material layer 7 on a pixel-by-pixel basis. Thus, the color material layers 7 of the respective colors are formed in a predetermined pattern on the color filter substrate 1. FIG. 3A illustrates the shape of the color material layer 7 of each color, and FIG. 3B is a plan view illustrating the color filter substrate 1 according to the second preferred embodiment. In FIG. 3B, the respective color material layers 7 of red (R), green (G) and blue (B) are disposed in stripe from the left.

The respective color material layers 7 are not a simple rectangle in the second preferred embodiment, as shown in FIG. 3A. Namely, the color material layer 7 shown in FIG. 3A has a shape that is provided with projections in positions superimposed upon the metal light-shielding film 5. These projections are to be superimposed upon the color material layers 7 of adjoining pixels, as shown in FIG. 3B. More specifically, on the metal light-shielding film 5 of the color material layer 7 of G are formed the color material layers 7 of adjoining pixels of R and G. Accordingly, the thickness over the metal light-shielding film 5 is increased by the three color material layers 7 to form convex portions. When forming the color material layers 7 in the order of B, G and R on the color filter substrate 1, the color material layers 7 are laminated in the order of B, G and R on the metal light-shielding film 5 as well.

A method of manufacturing the color filter substrate 1 according to the second preferred embodiment is basically identical to the first preferred embodiment, except that the positive photoresist 6 on the metal light-shielding film 5 is peeled off before laminating the color material layer 7 because the convex portions are formed by stacking a plurality of color material layers 7. The other steps are identical to those of the first preferred embodiment, so the detailed descriptions thereof are omitted.

Instead of having the shape shown in FIG. 3A, the color material layer 7 may have a shape such as shown in FIG. 4A. In short, while being provided with the projections on both sides thereof in FIG. 3A, the color material layer 7 in FIG. 4A is provided with projections only on the right side thereof. In addition, while one projection is superimposed only upon the color material layer 7 for one adjoining pixel in FIG. 3A, one projection is superimposed upon the color material layers 7 for two adjoining pixels in FIG. 4A.

FIG. 4B is a plan view illustrating the color filter substrate 1 formed of the color material layer 7 shown in FIG. 4A. The color filter substrate 1 shown in FIG. 4B is basically identical to the color filter substrate 1 shown in FIG. 3B, except that the projections of the color material layer 7 are formed extending over the metal light-shielding film 5 for adjoining two pixels on the right. The other respects are identical to those of FIG. 3B, so the detailed descriptions thereof are omitted.

Although the color material layers 7 of three colors of R, G and B are laminated on the metal light-shielding film 5 by way of example in the second preferred embodiment, this invention is not limited by this lamination, and the convex portions may be formed by laminating the color material layers 7 of at least two colors on the metal light-shielding film 5. The convex portions may be formed on the whole of, or alternatively a part of, the metal light-shielding film 5.

As described above, the liquid crystal display device according to the second preferred embodiment further includes the convex portions by increasing the thickness over at least part of the metal light-shielding film 5 by laminating the color material layers 7 of at least two colors, and the gap (cell gap) between the color filter substrate 1 and the TFT substrate 2 is defined by the spacers 3 interposed between the convex portions and the TFT substrate 2. Accordingly, light leakage is prevented and a predetermined contrast is attained without having to add new materials or steps for forming the convex portions, resulting in no increase in manufacturing cost.

Further, in the method of manufacturing the liquid crystal display device according to the second preferred embodiment, the color material layer 7 is formed on a pixel and also on the metal light-shielding film 5 of an adjoining pixel. Accordingly, the convex portions can be formed easily by increasing the thickness by laminating the color material layers 7 of at least two colors.

### Third Preferred Embodiment

As explained in the first and second preferred embodiments, the cell gap is defined only by the spacers 3 interposed between the convex portion and the TFT substrate 2. However, when the spacers 3 on the convex portions are few in the course of panel manufacture such as thermocompression bonding that applies pressure to the substrate, each of the spacers 3 is applied with increased pressure and thus smashes through the overcoat layer 8, cutting into the positive photoresist 6 and the color material layer 7. The diameter of the spacers 3 cutting in the positive photoresist 6 and the color material layer 7 will not be able to define the cell gap, which makes a desired structure unobtainable.

The main factor, therefore, is the relationship between the area on the convex portion (area on the metal light-shielding film 5 having been thickened) and the number of spacers 3 on the convex portion. In a third preferred embodiment of this invention, liquid crystal panels having different numbers of spacers 3 on the convex portion were manufactured by changing the area on the convex portion, scattering density of the spacers 3, and the diameter of the spacers 3, and then the degree of cutting in the color material layer 7 and the light leakage around the spacers were evaluated for each of the liquid crystal panels. The results of the evaluations are shown in Tables 1 and 2.

SPACER DIAMETER 3.5 μm

| PIXEL AREA | 0.03 mm² | 0.03 mm² | 0.03 mm² | 0.03 mm² | 0.03 mm² | 0.03 mm² | 0.03 mm² | 0.03 mm² | 0.03 mm² |
|---|---|---|---|---|---|---|---|---|---|
| SCATTERING DENSITY OF | 200/mm² | 200/mm² | 200/mm² | 300/mm² | 300/mm² | 300/mm² | 400/mm² | 400/mm² | 400/mm² |
| SPACERS | | | | | | | | | |
| AREA ON CONVEX | 8% | 10% | 12% | 8% | 10% | 12% | 8% | 10% | 12% |
| PORTION | | | | | | | | | |
| THE NUMBER OF SPACERS | 16 | 20 | 24 | 24 | 30 | 36 | 32 | 40 | 48 |
| ON CONVEX PORTION | | | | | | | | | |
| SPACER'S CUTTING IN | YES | YES | YES | YES | NO | NO | NO | NO | NO |
| COLOR MATERIAL LAYER | | | | | | | | | |
| LEVEL OF LIGHT LEAKAGE | 3 | 2 | 1 | 1 | 0 | 0 | 0 | 0 | 0 |
| AROUND SPACERS | | | | | | | | | |

SPACER DIAMETER 4.0 μm

| PIXEL AREA | 0.03 mm² | 0.03 mm² | 0.03 mm² | 0.03 mm² | 0.03 mm² | 0.03 mm² | 0.03 mm² | 0.03 mm² | 0.03 mm² |
|---|---|---|---|---|---|---|---|---|---|
| SCATTERING DENSITY OF | 200/mm² | 200/mm² | 200/mm² | 300/mm² | 300/mm² | 300/mm² | 400/mm² | 400/mm² | 400/mm² |
| SPACERS | | | | | | | | | |
| AREA ON CONVEX | 8% | 10% | 12% | 8% | 10% | 12% | 8% | 10% | 12% |
| PORTION | | | | | | | | | |
| THE NUMBER OF SPACERS | 16 | 20 | 24 | 24 | 30 | 36 | 32 | 40 | 48 |
| ON CONVEX PORTION | | | | | | | | | |
| SPACER'S CUTTING IN | YES | YES | NO | YES | NO | NO | NO | NO | NO |
| COLOR MATERIAL LAYER | | | | | | | | | |
| LEVEL OF LIGHT LEAKAGE | 2 | 1 | 0 | 1 | 0 | 0 | 0 | 0 | 0 |
| AROUND SPACERS | | | | | | | | | |

With respect to Table 1, evaluations were made by fixing the diameter of the spacers 3 to 3.5 μm, changing the scattering density of the spacers 3 to 200/mm², 300/mm² and 400/mm², and changing the area on the convex portion (the area on the convex portion with respect to the area of the display area is represented in ratio) to 8%, 10% and 12%. In the third preferred embodiment, the area of the display area indicates the sum of the area of a pixel (which is 0.03 mm² in Table 1) and the area of the metal light-shielding layer 5 (which is the convex portion), and the scattering density of the spacers 3 indicates the number of spacers 3 scattered per display area of 1 mm². The degree of cutting in the color material layer 7 was judged as “YES” or “NO” by visual inspection, and the light leakage around the spacers was judges as “3” for extremely strong leakage, “2” for strong leakage, “1” for weak leakage, and “0” for no leakage.

FIG. 5 is a graph illustrating the results of Tables 1 and 2, with the horizontal axis indicating the number of spacers 3 (per display area of 1 mm²) on the convex portion and the longitudinal axis indicating the level of light leakage around the spacers. In the FIG. 5 graph, black rhombuses indicate the spacer 3 having a diameter of 3.5 μm and white circles indicate the spacer 3 having a diameter of 4.0 μm, respectively.

It is understood from Table 1 and FIG. 5 that, with the spacer 3 having a diameter of 3.5 μm, at least thirty spacers 3 per display area of 1 mm² need to exist on the convex portion in order for the degree of cutting in the color material layer 7 to be “NO” and the light leakage around the spacers to be “0”.

Likewise, it is understood from Table 2 and FIG. 5 that, with the spacer 3 having a diameter of 4.0 μm, at least twenty-five spacers 3 per display area of 1 mm² need to exist on the convex portion in order for the degree of cutting in the color material layer 7 to be “NO” and the light leakage around the spacers to be “0”.

Therefore, the cutting in the color material layer 7 can be prevented and the light leakage around the spacers can be suppressed in the liquid crystal display device according to the third preferred embodiment by providing at least thirty spacers 3 having a diameter of 3.5 μm per display area of 1 mm² on the convex portion, and providing at least twenty-five spacers 3 having a diameter of 4.0 μm per display area of 1 mm² on the convex portion.

While the invention has been shown and described in detail, the foregoing description is in all aspects illustrative and not restrictive. It is therefore understood that numerous modifications and variations can be devised without departing from the scope of the invention.

What is claimed is:

1. A liquid crystal display device comprising:
a first substrate having a plurality of pixel electrodes formed thereon;
a second substrate facing said first substrate and having a metal light-shielding film formed thereon;
a liquid crystal held between said first substrate and said second substrate; and
a large number of spacers disposed in a gap between said first substrate and said second substrate,
wherein a voltage is applied between said pixel electrodes to generate an electric field substantially parallel to a surface of said first substrate, causing said liquid crystal to respond in an in-plane direction of said surface of said first substrate based on said electric field,
said liquid crystal display device further comprising a convex portion by increasing the thickness over at least part of said metal light-shielding film by using a photoresist,
wherein a dimension of said gap between said first substrate and said second substrate is defined by said spacers interposed between said convex portion and said first substrate among said large number of spacers.

2. A liquid crystal display device comprising:
a first substrate having a plurality of pixel electrodes formed thereon;
a second substrate facing said first substrate and having a metal light-shielding film and color material layers of at least two colors formed thereon;
a liquid crystal held between said first substrate and said second substrate; and
a large number of spacers disposed in a gap between said first substrate and said second substrate,
wherein a voltage is applied between said pixel electrodes to generate an electric field substantially parallel to a surface of said first substrate, causing said liquid crystal to respond in an in-plane direction of said surface of said first substrate based on said electric field,
said liquid crystal display device further comprising a convex portion by increasing the thickness over at least part of said metal light-shielding film by laminating said color material layers of at least two colors,
wherein a dimension of said gap between said first substrate and said second substrate is defined by said spacers interposed between said convex portion and said first substrate among said large number of spacers.

3. The liquid crystal display device according to claim 1, wherein at least thirty of said spacers per square millimeter display area exist on said convex portion, when having a diameter of 3.5 μm.

4. The liquid crystal display device according to claim 1, wherein at least twenty-five of said spacers per square millimeter display area exist on said convex portion, when having a diameter of 4.0 μm.

5. The liquid crystal display device according to claim 2, wherein at least thirty of said spacers per square millimeter display area exist on said convex portion, when having a diameter of 3.5 μm.

6. The liquid crystal display device according to claim 2, wherein at least twenty-five of said spacers per square millimeter display area exist on said convex portion, when having a diameter of 4.0 μm.

7. A method of manufacturing a liquid crystal display device, said liquid crystal display device comprising:
a first substrate having a plurality of pixel electrodes formed thereon;
a second substrate facing said first substrate and having a metal light-shielding film formed thereon;
a liquid crystal held between said first substrate and said second substrate;
a large number of spacers disposed in a gap between said first substrate and said second substrate; and
a convex portion by increasing the thickness over at least part of said metal light-shielding film by using a photoresist, wherein
a voltage is applied between said pixel electrodes to generate an electric field substantially parallel to a surface of said first substrate, causing said liquid crystal to respond in an in-plane direction of said surface of said first substrate based on said electric field, and
a dimension of said gap between said first substrate and said second substrate is defined by said spacers interposed between said convex portion and said first substrate among said large number of spacers,
said method comprising the steps of:
forming said metal light-shielding film made of a predetermined material on said second substrate;
forming said photoresist on said metal light-shielding film;
patterning said metal light-shielding film by exposing said photoresist with a predetermined photomask and etching said photoresist thereafter; and
laminating a color material layer without peeling off said photoresist on said metal light-shielding film.

8. A method of manufacturing a liquid crystal display device, said liquid crystal display device comprising:
a first substrate having a plurality of pixel electrodes formed thereon;
a second substrate facing said first substrate and having a metal light-shielding film and color material layers of at least two colors formed thereon;
a liquid crystal held between said first substrate and said second substrate;
a large number of spacers disposed in a gap between said first substrate and said second substrate; and
a convex portion by increasing the thickness over at least part of said metal light-shielding film by laminating said color material layers of at least two colors, wherein
a voltage is applied between said pixel electrodes to generate an electric field substantially parallel to a surface of said first substrate, causing said liquid crystal to respond in an in-plane direction of said surface of said first substrate based on said electric field, and
a dimension of said gap between said first substrate and said second substrate is defined by said spacers interposed between said convex portion and said first substrate among said large number of spacers,
said method comprising the steps of forming one of said color material layers on a pixel and forming, at the same time, said one of said color material layers on said metal light-shielding film of an adjoining pixel to said pixel.
